(19) United States
(12) Patent Application Publication
(10) Pub. No.: US 2009/0008917 A1
(43) Pub. Date: Jan. 8, 2009

(54) Landing gear jack and methods of use

(76) Inventor: Jeffrey K. Daniel, Houston, TX (US)

Correspondence Address: Houston IP Department;JACKSON WALKER L.L.P., 1401 McKinney St., Suite 1900, Houston, TX, 77010, US

(21) Appl. No.: 11/824,821

(22) Filed: Jul. 3, 2007

(51) Int. Cl. B60S 9/12; B60P 1/00

(52) U.S. Cl. 280/766.1; 254/419

(57) ABSTRACT

A lifting device is provided for raising and lowering of heavy objects, including trailer landing gear and outriggers. The lifting devices may comprise one or more jacks where each jack is comprised of telescoping legs. In each jack, an expandable hydraulic cylinder may be expanded or extended by a pneumatically actuated pump or pumps that pump hydraulic fluid from a hydraulic fluid source mounted on the jack to the expandable hydraulic cylinder so as to motivate extension of each telescoping jack. A control mechanism may be provided to actuate one or more pneumatically actuated pumps to introduce hydraulic fluid into the hydraulic cylinders. Methods of use and operation are also provided.

### BACKGROUND

The present invention relates to landing gear extension and retraction mechanisms, and more particularly to pneumatically actuated lifting devices for trailer landing gear and outriggers and methods of use.

Many semi-trailers have front landing gear for support of the front of the trailer when the truck or tractor is detached. Such landing gears generally have two spaced-apart, telescoping or jack-type landing gear legs and feet which extend downwardly from the floor of the trailer. Each leg is operatively attached to a screw and follower or a rack and pinion gear arrangement which is driven by a landing gear drive shaft which extends between the legs and which causes extension or retraction of the legs and feet depending on the direction in which it is rotated.

Traditionally, a hand operable handle or crank is attached to the landing gear drive shaft by a pin or bolt, which serves as a hinge connection allowing the handle to be pivoted out of the way when not in use. Manual rotation of the handle in one direction causes extension of the feet and lifting of the trailer to, for example, separate the trailer from a semi-tractor, and requires considerable time and effort on the part of the person manually rotating the hand crank. Manually operated jack structures, however, are often difficult to use, require much time for their operation and expose the operator to potential injuries as he is positioned next to the trailer while turning the crank to raise or lower the landing gear to in turn raise or lower the trailer.

Thus, prior art attempts have been made to reduce the effort required to manually operate the crank handle. For example, a two-speed gear box, referred to as a gear reduction box, is typically included in the prior art landing gear to allow the hand crank handle to be attached to either a high speed or low speed input shaft of the gear box. The gear ratio utilized within the gear reduction box assembly depends upon the lateral positioning of the crank shaft and the outer diameter of the spur gears utilized in the gear box. In any event, the primary type of gear utilized in these gear boxes, as well as to transfer crank handle input power to the gear boxes, is the basic spur gear, and more recently, worm gears.

Another attempt in the prior art to reduce operator input effort has been to retrofit existing landing gear with powered devices in order to raise and lower the landing gear. Generally, such retrofitted devices require an intricate system of spacers, pulleys and gearing that is both comparatively expensive and difficult to implement. This is especially true since the powered devices must be retrofitted to operate with gear reduction boxes. In some cases, the powered devices for replacing the hand crank have been pneumatically powered, although other power means have been used for the purpose. Typically, even beyond the general retrofit system, such pneumatic devices require a complex system to receive pressurized air for the actuators to rotate the crank shaft of the gear reduction assembly to raise and lower the landing gear. One class of prior art pneumatic devices has utilized pneumatic impact motors to drive the landing gear. Those skilled in the art understand that due to their pulsating drive mechanism, such pneumatic impact motors are not conducive to the desired smooth operation of raising and lowering the landing gear legs, especially in combination with gear reduction boxes.

Another proposed pneumatic mechanism dispenses with the gearing system of traditional landing gear and utilizes a pneumatic bladder to telescope the landing gear legs. These elongated pneumatic bladders, however, are difficult to design and work poorly. The expandable bladders include a risk of rupture of the bladder. Additionally, retaining pressure in the bladder is complicated at times due to leaks. Whichever type of pneumatic actuation system is used, however, such devices generally are permanently retrofitted as an integrated part of the reduction box and drive system of the landing gear.

Conventional piston driven hydraulic devices similar to the pneumatic air bladder system referenced above replace traditional gearing systems. The conventional piston driven hydraulic devices utilize electrically-actuated pumps to actuate the hydraulic pistons with oil. Such devices utilize power packs (i.e. DC motors, reservoirs, and gear pumps), and consequently, they typically require a fairly high amperage to drive the hydraulic pistons with oil. One drawback to conventional hydraulic pistons is that they may not provide the same positive holding as provided by a gearing arrangement. A power failure could cause failure and collapse of the landing gear. Additionally, such systems are generally large due to, among other reasons, the additional power system requirements, and consequently, are cumbersome and permanently installed as an integrated part of the drive system. Moreover, such systems require more components and more complexity due to the pumps being electrically-actuated.

Still yet other drive mechanisms have focused on the use of electric motors without the use of hydraulic pistons. The desirability of electric motors for powering landing gear is that they are generally easy to operate and require a less complicated motor control system. As with other types of motors, however, electric motors usually require specialized parts to link the motor to the gear mechanism and the motors are installed as an integral, permanent component of the landing gear system.

Because of the complexity and expense of prior art landing gear systems for raising and lowering landing gear, such systems have not been widely accepted in the trucking industry. Thus, the old fashioned hand crank systems driven by a gear system still predominate in the field. Also, because of the prior art's complexity and need for specialized parts, many of these systems have proven to be fragile and generally unsuitable to the rugged demands of long-haul semi-trailers in use on a daily basis.

Each of the various types of prior art methods for actuating landing gear have their benefits and drawbacks. It would therefore be desirable to provide landing gear lifting systems that address one or more of the disadvantages of the prior art systems.

### SUMMARY

The present invention relates to landing gear extension and retraction mechanisms, and more particularly to pneumatically actuated lifting devices for trailer landing gear and outriggers and methods of use.

One example of a landing gear lifting device for actuating a landing gear of a trailer, the lifting device comprises: a first jack, the first jack comprising a first tubular body in which a second tubular body is telescopically mounted; a first hydraulic cylinder disposed in the first jack wherein the first hydraulic cylinder is capable of being telescopically extended through the introduction of hydraulic fluid into the first hydraulic cylinder; a first hydraulic fluid reservoir mounted on the first jack; a first pneumatically actuated pump for introducing hydraulic fluid into the first hydraulic cylinder; a second jack, the second jack comprising a third tubular body in which a fourth tubular body is telescopically mounted; a second hydraulic cylinder disposed in the second jack wherein the second hydraulic cylinder is capable of being telescopically extended through the introduction of hydraulic fluid into the second hydraulic cylinder; a second hydraulic fluid reservoir mounted on the second jack; a second pneumatically actuated pump for introducing hydraulic fluid into the second hydraulic cylinder; and a control mechanism to actuate the first and second pneumatically actuated pumps.

Another example of a gearless landing gear lifting device for actuating a landing gear of a trailer, the gearless lifting device comprises: a first jack, the first jack comprising a first tubular body in which a second tubular body is telescopically mounted; a first hydraulic cylinder disposed in the first jack wherein the first hydraulic cylinder is capable of being telescopically extended through the introduction of hydraulic fluid into the first hydraulic cylinder; a second jack, the second jack comprising a third tubular body in which a fourth tubular body is telescopically mounted; a second hydraulic cylinder disposed in the second jack wherein the second hydraulic cylinder is capable of being telescopically extended through the introduction of hydraulic fluid into the second hydraulic cylinder; a hydraulic fluid reservoir; a pneumatically actuated pump for introducing hydraulic fluid into the first and second hydraulic cylinders, wherein the pump has a first port in fluid communication with the hydraulic fluid reservoir and a second port in fluid communication with the first and second hydraulic cylinders and a pneumatically actuated impeller disposed to pump hydraulic fluid between the hydraulic fluid reservoir and the hydraulic cylinders; and a control mechanism to actuate the pneumatically actuated pump.

An example of a method for lifting a landing gear of a trailer landing comprises: providing a first jack, the first jack comprising a first tubular body in which a second tubular body is telescopically mounted and a first hydraulic cylinder disposed in the first jack wherein the first hydraulic cylinder is capable of being telescopically extended through the introduction of pneumatic fluid into the first hydraulic cylinder by a first pneumatically actuated hydraulic fluid pump; providing a second jack, the second jack comprising a third tubular body in which a fourth tubular body is telescopically mounted and a second hydraulic cylinder disposed in the second jack wherein the second hydraulic cylinder is capable of being telescopically extended through the introduction of hydraulic fluid into the second hydraulic cylinder by a second pneumatically actuated hydraulic fluid pump; providing a control mechanism to actuate the first pneumatic pump and the second pneumatic pump; and introducing hydraulic fluid into the first hydraulic cylinder with the first pneumatically actuated pump and introducing hydraulic fluid into the second hydraulic cylinder with the second pneumatically actuated pump.

An example of a trailer having a gearless landing gear lifting device for lifting the trailer, the trailer comprises: a trailer; and a landing gear lifting device fixed to the trailer wherein the landing gear lifting device comprises a first jack, the first jack comprising a first tubular body in which a second tubular body is telescopically mounted; a first hydraulic cylinder disposed in the first jack wherein the first hydraulic cylinder is capable of being telescopically extended through the introduction of hydraulic fluid into the first hydraulic cylinder; a second jack, the second jack comprising a third tubular body in which a fourth tubular body is telescopically mounted; a second hydraulic cylinder disposed in the second jack wherein the second hydraulic cylinder is capable of being telescopically extended through the introduction of hydraulic fluid into the second hydraulic cylinder; a hydraulic fluid reservoir; a pneumatically actuated pump for introducing hydraulic fluid into the first and second hydraulic cylinders, wherein the pump has a first port in fluid communication with the hydraulic fluid reservoir and a second port in fluid communication with the first and second hydraulic cylinders and a pneumatically actuated impeller disposed to pump hydraulic fluid between the hydraulic fluid reservoir and the hydraulic cylinders; and a control mechanism to actuate the pneumatically actuated pump.

The features and advantages of the present invention will be apparent to those skilled in the art. While numerous changes may be made by those skilled in the art, such changes are within the spirit of the invention.

### BRIEF DESCRIPTION OF THE DRAWINGS

A more complete understanding of the present disclosure and advantages thereof may be acquired by referring to the following description taken in conjunction with the accompanying figures, wherein:

FIG. 1 illustrates a conventional landing gear jack.

FIG. 2 is a perspective view of an example of a landing gear jack in accordance with one embodiment of the present invention.

FIG. 3 is a cross-sectional view of an example of a landing gear jack.

FIG. 4 is an exploded view of an example of a landing gear jack.

FIG. 5 is a cross-sectional view of an example of a landing gear jack.

FIG. 6 is a perspective view of an example of a landing gear jack with a mechanically-actuated pump.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DESCRIPTION OF PREFERRED EMBODIMENTS

The present invention relates to landing gear extension and retraction mechanisms, and more particularly to pneumatically actuated lifting devices for trailer landing gear and outriggers and methods of use.

Generally, the present invention uses a first telescoping jack and a second telescoping jack for raising the landing gear of trailers, work trucks, or other heavy objects that need to be raised. Each jack is comprised of a outer tubular body and an inner tubular body, the inner tubular body capable of nesting inside the outer tubular body. A hydraulic cylinder within each jack causes the inner tubular body to telescopically extend by extension of the hydraulic cylinder within each jack. The hydraulic cylinder may be extended by forcing or otherwise introducing hydraulic fluid into the hydraulic cylinder so as to motivate the hydraulic cylinder to extend, which in turn causes each jack to telescopically extend. In this way, the jacks are capable of raising an object, such as a trailer. One or more pneumatically actuated pumps may be used to introduce hydraulic fluid into each hydraulic cylinder. In certain embodiments, two or more jacks may be attached together to form one integral unit. Methods of use and methods of operation are also provided herein.

Advantages of the lifting devices of the present invention include, but are not limited to, improved, smoother, and more efficient living of heavy objects. Additionally, the lack of moving parts, such as moving gears, in certain embodiments reduces failures that would be attributable to such parts.

Although the lifting devices herein are discussed in the context of raising the landing gear of a trailer, it is recognized that the lifting devices described herein could be used to raise any suitable heavy object as desired. Suitable heavy objects include, but are not limited to, outrigger assemblies, work trucks, trailers, a long chassis, heavy machinery, or any combination thereof.

To facilitate a better understanding of the present invention, the following examples of certain embodiments are given. In no way should the following examples be read to limit, or define, the scope of the invention.

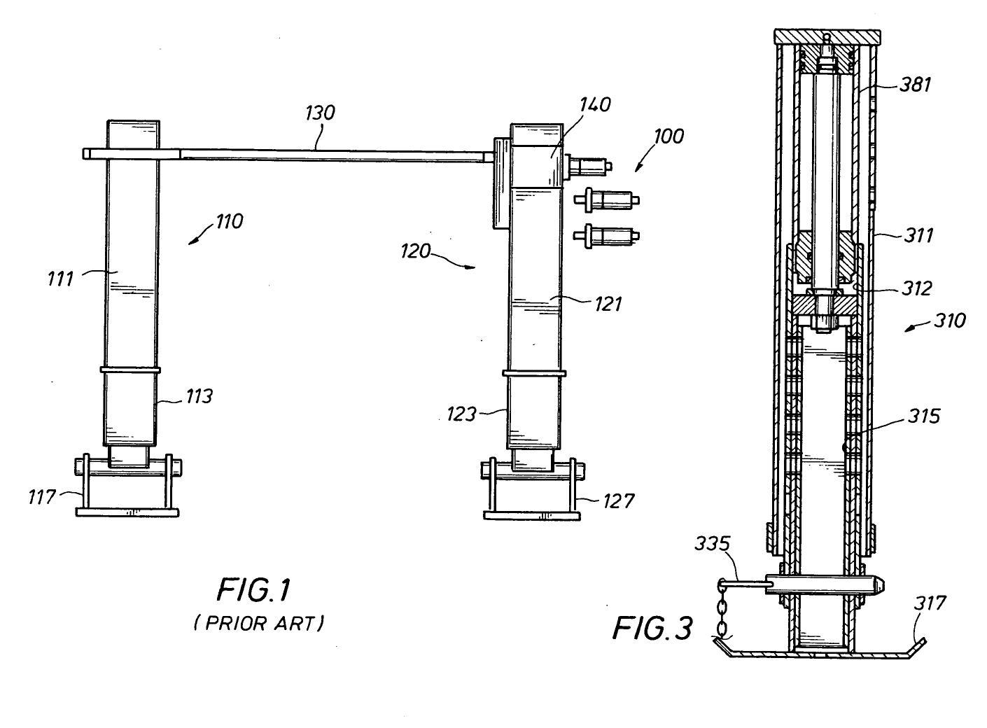

FIG. 1 illustrates a conventional landing gear assembly. Conventional landing assembly 100 is comprised of first jack 110 and second jack 120. First leg 111 of first jack 110 telescopically receives inner tubular portion 113. Likewise, second leg 121 of second jack 120 telescopically receives inner tubular portion 123. Pivotally mounted feet, wheels, or pads 115 & 125 attach to the distal end of each inner tubular portion 113 & 123. Conventional gear mechanisms (not shown) inside gear drive 140 cause the inner tubular portions 113 & 123 to raise or lower by actuation of the telescoping gear mechanisms (not shown) within first jack 110 and second jack 120, depending upon the direction of rotation of the drive shaft 130. Often, as is common in the art, conventional landing gear 100 includes a gear reduction box (not shown).

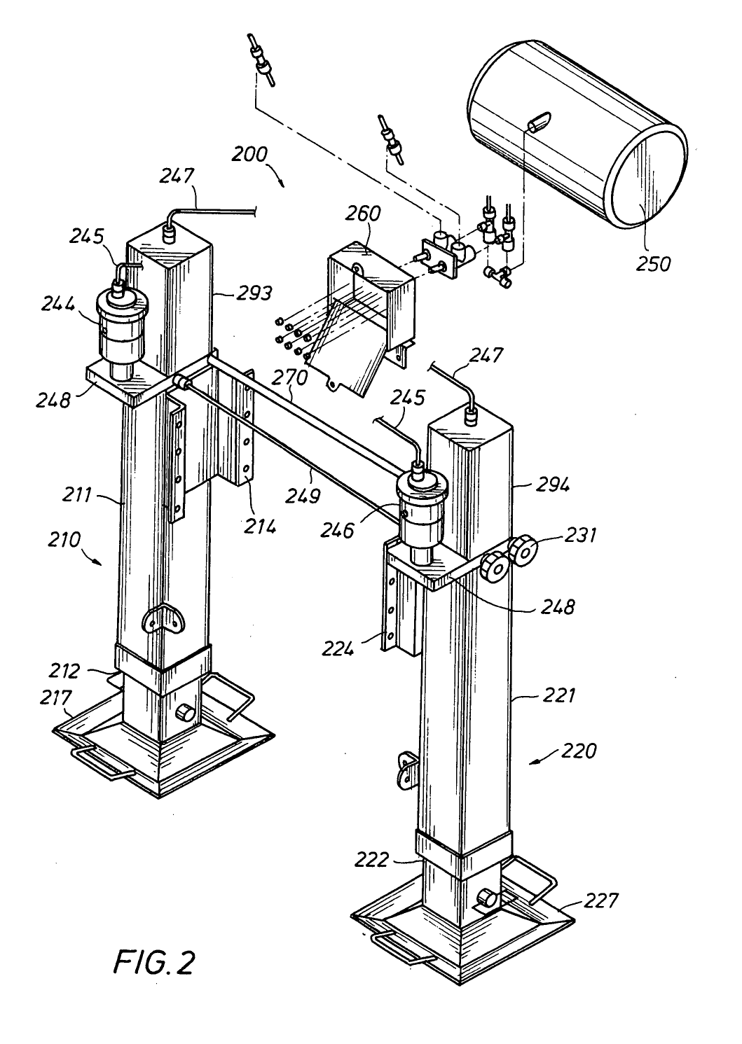

FIG. 2 is a perspective view of an example of a landing gear jack in accordance with one embodiment of the present invention.

Lifting device 200 comprises first jack 210 and second jack 220. Mounting brackets 214 and 224 allow jacks 210 & 220 to be attached to the landing gear of a trailer (not shown) or any suitable heavy object for lifting as desired. Jack 210 is comprised of telescoping legs, first tubular body 211 and second tubular body 212. Likewise, jack 220 is comprised of third tubular body 221 and fourth tubular body 222. Jacks 210 & 220 contain telescoping hydraulic cylinders (not visible in FIG. 1), which can be extended in jacks 210 & 220 by introducing hydraulic fluid into each hydraulic cylinder. The extension of each air cylinder causes tubular bodies 212 & 222 to telescopically extend from tubular bodies 211 & 221. In this way, jacks 210 & 220 may be used to raise a heavy object, in this case, the landing gear of a trailer.

Pivotally mounted feet or pads 217 & 227 are attached to tubular bodies 211 & 221 to provide a stable surface area upon which jacks 212 & 222 may act.

Pneumatically actuated pumps 244 & 246 may be used to pump or otherwise introduce a hydraulic fluid into the telescoping hydraulic cylinders. Any suitable hydraulic fluid may be provided from a suitable hydraulic fluid reservoir, in this case, first hydraulic fluid reservoir 293 and second hydraulic fluid reservoir 294, which may any suitable hydraulic fluid, including, for example, an oil, water, or polypropylene glycol. Polypropylene glycol may be preferred in certain embodiments as it is environmentally favored (i.e. FDA approved as a food additive), is readily available (i.e. sold as an engine coolant), and is not corrosive.

Pumps 244 & 246 pump hydraulic fluid through flow conduits 248 to the hydraulic cylinders (not shown) in jacks 211 & 221 via fluid ports contained in flow conduits 248. Flow equalizer tubing 249 allows for flow of hydraulic fluid between hydraulic cylinders 211 & 221 in those embodiments in which such equalization may be desired.

Pneumatically actuated pumps 244 & 246 may be driven by pressurized air or gas from any suitable source, including on-board air reservoir 250. Suitable sources of air include, but are not limited to, air from the air-ride suspension system, the air brake system, an on-board air reservoir, or any combination thereof. Where sufficient pneumatic flow capacity is not available to drive pumps 244 & 246, lower capacity pneumatically-actuated pumps may be used in conjunction with an air reservoir, which can “store up” pressured air or gas to deliver the quantity of air or gas required to actuate pumps 244 & 246. Alternatively, air reservoir 250 may be supplied pressurized air from any suitable source.

Valve control box 260 contains valves for controlling/metering the flow of air from air reservoir 250 to pneumatically actuated pumps 244 & 246. Tubing 245 allows for the flow of air or gas from air reservoir 250 through valve control box 260 to pneumatically actuated pumps 244 & 246.

Controls 231 may be adjusted by the user to control actuation of pumps 244 & 246. Controls 231 may be used to simultaneously actuate both pumps 244 & 246 together or independently of one another. Although controls 231 are depicted on the side of outer leg 221, it is recognized that controls 231 may be positioned anywhere on lifting device 200 or otherwise, including mounting controls 231 at a position remotely situated from lifting device 200. Mounting controls 231 remotely to lifting device 200 may be desirable in those instances where it is desirable to avoid an operator having to be located adjacent to lifting device 200 where such proximity could result in the operator being exposed to a roadway or other hazardous condition.

Optionally, tubing 247 allows for the introduction of air or gas into the head space of hydraulic fluid reservoirs 293 & 294 to facilitate flow of hydraulic fluid to pumps 244 & 246.

FIG. 3 is a cross-sectional view of an example of a landing gear jack 310 second tubular body 312 is telescopically disposed in first tubular body 311. In this view, hydraulic cylinder 381 is apparent in its non-telescoped state in first tubular body 311. Upon introducing hydraulic fluid into hydraulic cylinder 381, hydraulic cylinder 381 telescopically extends so as to cause first second tubular body 312 to telescopically extend from first tubular body 311. In this way, jack 310 may be used to raise heavy objects. Pivotally mounted feet or pads 317 provide a stable contact area upon which jack 310 may engage a surface, such as the ground.

Drop down leg 315 is held in place by locking pin 335. When a trailer is in its raised position (e.g. resting on a truck), one may wish to extend jack 310 to allow the trailer to rest on jack 310. Further extension of jack 310 could be used to raise the trailer sufficiently to allow removal of the truck from under the trailer. One option to accomplish this task would be to simply extend jack 310 as previously described, by extension of air cylinder 381. Another option is to remove locking pin 335 and allow drop down leg 315 to drop to the ground. Replacing locking pin 335 while drop down leg 315 is in its extended position locks drop down leg 315 into the extended position. Thus, hydraulic cylinder 381 now only has to extend a slight amount to raise the trailer sufficiently to allow the removal of the truck. In this way, drop down leg 315 conserves time, stored hydraulic fluid, and the usage of the pneumatically actuated pumps.

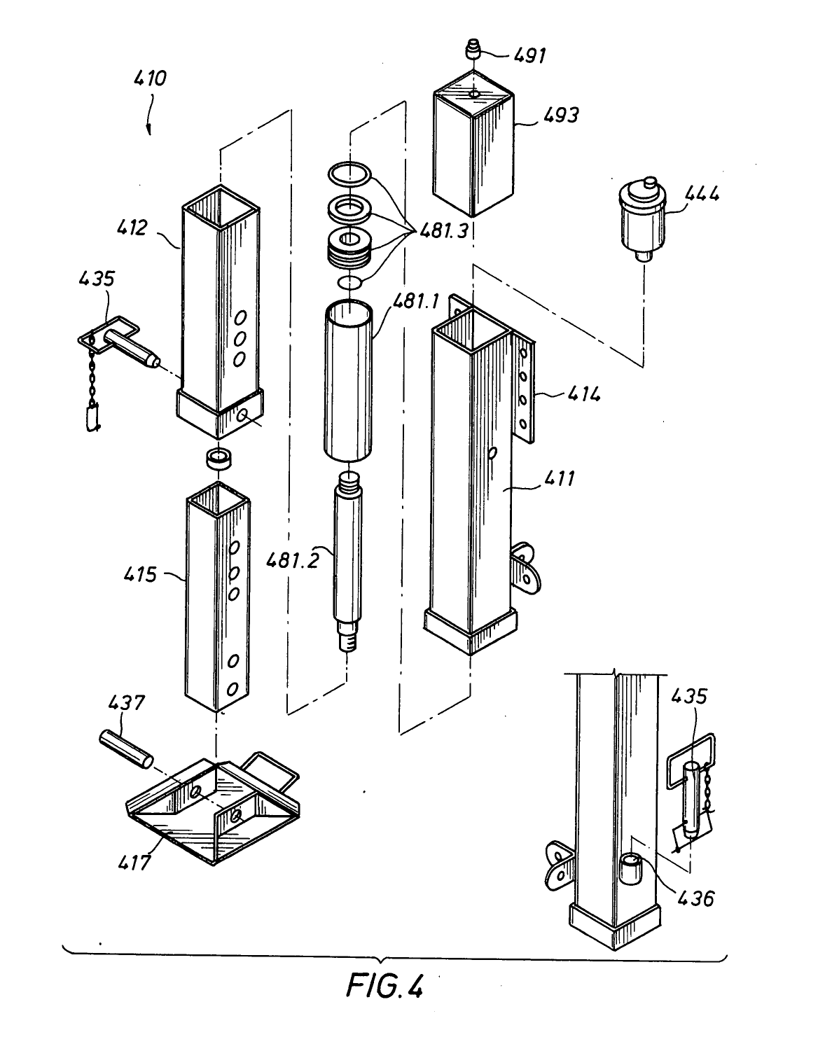

FIG. 4 is an exploded view of an example of a landing gear jack 410. In this exploded view, first tubular body 411 is shown apart from second tubular body 412. Mounting bracket 414 is fixed to first tubular body 411. Drop down leg 415 is capable of being telescopically inserted into second tubular body 412. Locking pin 435 locks drop down leg 415 at a fixed extension from second tubular body 412. Locking pin retainer 436 may be used to store locking pin 435 when locking pin 435 is not needed.

Pivotally mounted feet or pads 417 provide a stable contact area upon which jack 310 may engage a surface, such as the ground. Articulation pin 417 attaches pivotally mounted feet or pads 417 to drop down leg 412. Articulation pin 417 allows pivotally mounted feet or pads 417 to adjust to the angle of the ground or surface to which pivotally mounted feet or pads 417 is engaging.

Hydraulic cylinder 481 is comprised of cylinder skirt 481.1 and cylinder piston 481.2. Cylinder seals and packing 481.3 provide an air tight seal for hydraulic cylinder 481. By forcing hydraulic fluid into cylinder skirt 481.1, cylinder piston 481.2 is motivated to telescopically extend. This extension of air cylinder 481 motivates first tubular body 411 and second tubular body 412 to telescopically extend apart from one another. Breather valve 491 (or alternatively a pressure safety valve) on reservoir cap 492 allows air to be expelled or introduced as necessary when hydraulic fluid is being cycled from hydraulic fluid reservoir 493. Additionally, valve 491 may be used to allow for the escape of hydraulic fluid from hydraulic fluid reservoir 493 in an overpressure situation.

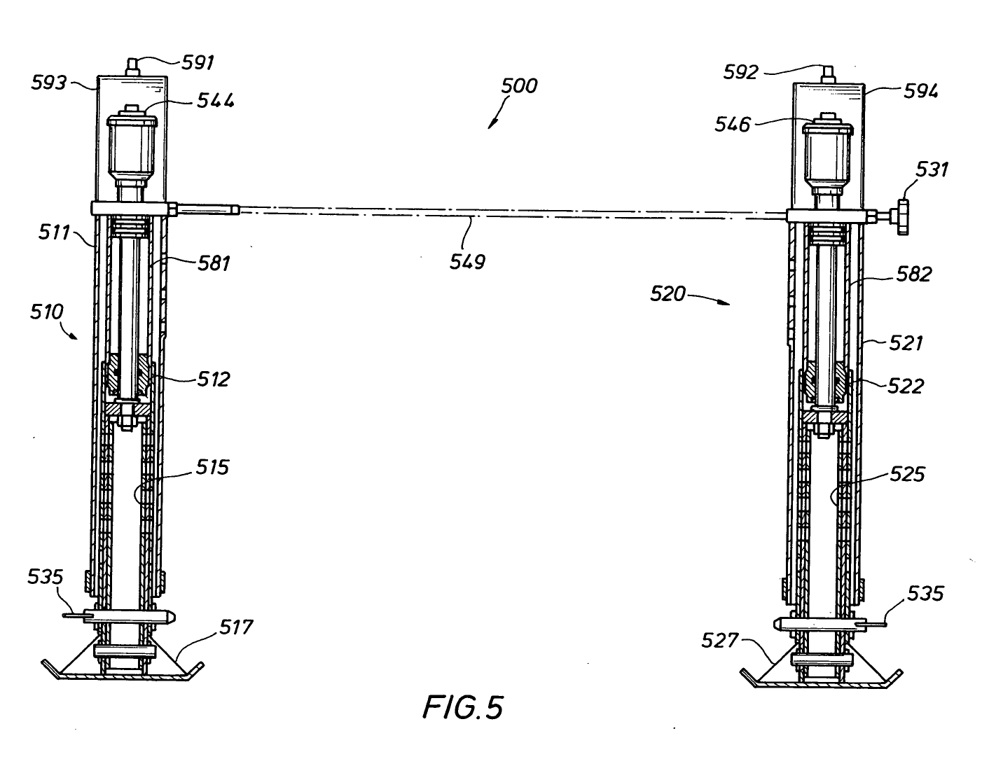

FIG. 5 is a cross-sectional view of an example of a landing gear jack 500 comprised of a first jack 510 and a second jack 520. Similar to previous embodiments, inner tubular bodies 512 & 522 are telescopically disposed in outer tubular bodies 511 & 521. Hydraulic cylinders 581 & 582 are at least partially disposed in outer tubular bodies 511 & 521. Pneumatically actuated pumps 544 & 546 introduce air into air cylinders 581 & 582. In this depiction, for completeness, hydraulic fluid reservoirs 593 & 594 are shown in the same cross-sectional view even though hydraulic fluid reservoirs 593 & 594 are actually situated behind pumps 544 & 546 (therefore, dotted lines have been used to depict hydraulic fluid reservoirs 544 & 546 as hydraulic fluid reservoirs 544 & 546 are not located in the same plane as pumps 544 & 546).

Locking pins 535 fix drop down legs 515 & 525 at a desired fixed extension, with pivotable feet or pads 517 & 527 providing a contact area upon which jacks 510 & 520 may rest upon a surface. Controls 531 allow control of pneumatically actuated pumps 544 & 546 together or independently of one another. It is recognized that pneumatically actuated pumps 544 & 546, in certain embodiments, may be pneumatically driven by any suitable air source, including, but not limited to a high-pressure gas source, an air reservoir, the atmosphere, or any combination thereof. It is further recognized that one pneumatically actuated pump may be used to supply hydraulic fluid to both hydraulic cylinders 581 & 582. In certain embodiments, equalizer tubing 549 allow for the flow of hydraulic fluid between hydraulic cylinders 581 & 582.

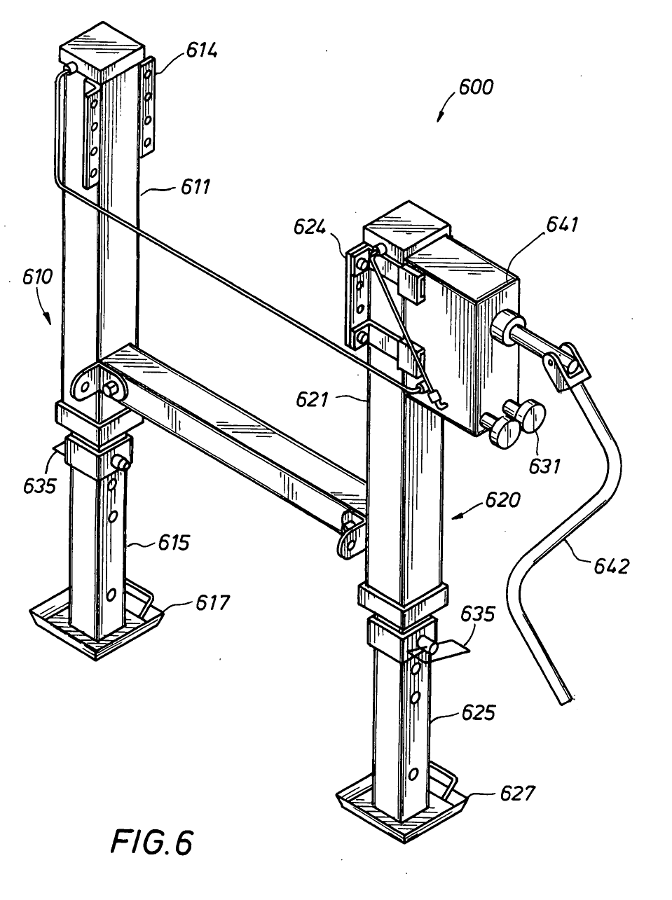

FIG. 6 is a perspective view of an example of a landing gear jack with a mechanically-actuated pump. Here, mechanically-driven pneumatic pump 641 is actuated via hand-crank 642. Pump 641 introduces hydraulic fluid via hydraulic fluid tubing 647 into hydraulic cylinders (not shown) in jacks 610 & 620. Similar to previously discussed embodiments, inner tubular bodies 612 & 622 (not shown) telescopically extend from outer tubular bodies 611 & 621. Locking pins 535 lock drop down legs 615 & 625 at a fixed extension as desired. Pivotally-mounted feet or pads 617 & 627 are attached to drop down legs 615& 625. Bracing member 675 provides additionally structural integrity and stability to jacks 610 and 620.

It is expressly recognized herein that the term “tubular” imposes no particular shape on the tubular bodies disclosed herein. Although in certain embodiments, the tubular bodies herein may have been disclosed as substantially square-shaped, it is recognized that the tubular bodies may have any suitable shape, including but not limited to substantially cylindrical or substantially rectangular.

The various components of the lifting devices may be constructed of any material known in the art suitable for withstanding the environmental conditions to which the devices may be exposed, including, but not limited to, stainless steel, the various metals known in the art, the various metal alloys known in the art, the various plastics known in the art, composite or synthetic materials known in the art, or any combination thereof.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. A landing gear lifting device for actuating a landing gear of a trailer, the lifting device comprising:
a first jack, the first jack comprising a first tubular body in which a second tubular body is telescopically mounted;
a first hydraulic cylinder disposed in the first jack wherein the first hydraulic cylinder is capable of being telescopically extended through the introduction of hydraulic fluid into the first hydraulic cylinder;
a first hydraulic fluid reservoir mounted on the first jack;
a first pneumatically actuated pump for introducing hydraulic fluid into the first hydraulic cylinder;
a second jack, the second jack comprising a third tubular body in which a fourth tubular body is telescopically mounted;
a second hydraulic cylinder disposed in the second jack wherein the second hydraulic cylinder is capable of being telescopically extended through the introduction of hydraulic fluid into the second hydraulic cylinder;
a second hydraulic fluid reservoir mounted on the second jack;
a second pneumatically actuated pump for introducing hydraulic fluid into the second hydraulic cylinder; and
a control mechanism to actuate the first and second pneumatically actuated pumps.

2. The landing gear lifting device of claim 1 wherein the first jack and the second jack are disengaged from one another.

3. The landing gear lifting device of claim 1 wherein the first jack and the second jack operate without a gear box.

4. The landing gear lifting device of claim 1 wherein the first jack operates independently of the second jack.

5. The landing gear lifting device of claim 1 wherein the control mechanism is capable of actuating the first pneumatically actuated pump independently of the second pneumatically actuated pump.

6. The landing gear lifting device of claim 1 wherein the control mechanism is capable of synchronously actuating both the first pneumatically actuated pump and the second pneumatically actuated pump.

7. The landing gear lifting device of claim 1 wherein the control mechanism is capable of controlling a rate of actuation of the first pneumatically actuated pump and the second pneumatically actuated pump.

8. The landing gear lifting device of claim 1 wherein the first jack further comprises a first drop down leg telescopically mounted to the first jack and wherein the second jack further comprises a second drop down leg telescopically mounted to the second jack.

9. The landing gear lifting device of claim 8 further comprising a lock down pin for securing the first drop down leg at a fixed telescoped position.

10. The landing gear lifting device of claim 1 wherein the first pneumatically actuated pump is disposed in fluid communication with the first hydraulic fluid reservoir and the first hydraulic cylinder and wherein the second pneumatically actuated pump is disposed in fluid communication with the second hydraulic fluid reservoir and the second hydraulic cylinder.

11. The landing gear lifting device of claim 1 wherein the first pneumatically actuated pump is operable by a mechanically-actuated hand crank.

12. The landing gear lifting device of claim 10 further comprising a mechanically-actuated hand crank for driving the first pneumatically actuated pump as a backup to the pneumatic motor.

13. The landing gear lifting device of claim 1 further comprising a bracing member attaching the first jack to the second jack for additional stability and integrity of the landing gear lifting device.

14. A gearless landing gear lifting device for actuating a landing gear of a trailer, the gearless lifting device comprising:
a first jack, the first jack comprising a first tubular body in which a second tubular body is telescopically mounted;
a first hydraulic cylinder disposed in the first jack wherein the first hydraulic cylinder is capable of being telescopically extended through the introduction of hydraulic fluid into the first hydraulic cylinder;
a second jack, the second jack comprising a third tubular body in which a fourth tubular body is telescopically mounted;
a second hydraulic cylinder disposed in the second jack wherein the second hydraulic cylinder is capable of being telescopically extended through the introduction of hydraulic fluid into the second hydraulic cylinder;
a hydraulic fluid reservoir;
a pneumatically actuated pump for introducing hydraulic fluid into the first and second hydraulic cylinders, wherein the pump has a first port in fluid communication with the hydraulic fluid reservoir and a second port in fluid communication with the first and second hydraulic cylinders and a pneumatically actuated impeller disposed to pump hydraulic fluid between the hydraulic fluid reservoir and the hydraulic cylinders; and
a control mechanism to actuate the pneumatically actuated pump.

15. The landing gear lifting device of claim 14 wherein the first jack and the second jack are disengaged from one another.

16. The landing gear lifting device of claim 14 wherein the first jack and the second jack operate without a gear box.

17. A method for lifting a landing gear of a trailer landing comprising:
providing a first jack, the first jack comprising a first tubular body in which a second tubular body is telescopically mounted and a first hydraulic cylinder disposed in the first jack wherein the first hydraulic cylinder is capable of being telescopically extended through the introduction of pneumatic fluid into the first hydraulic cylinder by a first pneumatically actuated hydraulic fluid pump;
providing a second jack, the second jack comprising a third tubular body in which a fourth tubular body is telescopically mounted and a second hydraulic cylinder disposed in the second jack wherein the second hydraulic cylinder is capable of being telescopically extended through the introduction of hydraulic fluid into the second hydraulic cylinder by a second pneumatically actuated hydraulic fluid pump;
providing a control mechanism to actuate the first pneumatic pump and the second pneumatic pump; and
introducing hydraulic fluid into the first hydraulic cylinder with the first pneumatically actuated pump and introducing hydraulic fluid into the second hydraulic cylinder with the second pneumatically actuated pump.

18. The method of claim 17 further comprising removing hydraulic fluid from the first hydraulic cylinder and the second hydraulic cylinder.

19. The method of claim 17 further comprising providing a pneumatic port in the hydraulic fluid reservoir for introducing a gas and introducing the gas into the hydraulic fluid reservoir so as to increase a head pressure on the hydraulic fluid in the hydraulic fluid reservoir.

20. The method of claim 17 wherein the hydraulic fluid is oil and the gas is air.

21. The method of claim 17 wherein the hydraulic fluid is water or polyethylene glycol.

22. The method of claim 17 further comprising providing a pneumatic source wherein the pneumatic source is an air reservoir.

23. The method of claim 22 wherein the air reservoir is mounted adjacent the landing gear.

24. A trailer having a gearless landing gear lifting device for lifting the trailer, the trailer comprising:
a trailer; and
a landing gear lifting device fixed to the trailer;
wherein the landing gear lifting device comprises:
a first jack, the first jack comprising a first tubular body in which a second tubular body is telescopically mounted;
a first hydraulic cylinder disposed in the first jack wherein the first hydraulic cylinder is capable of being telescopically extended through the introduction of hydraulic fluid into the first hydraulic cylinder;
a second jack, the second jack comprising a third tubular body in which a fourth tubular body is telescopically mounted;
a second hydraulic cylinder disposed in the second jack wherein the second hydraulic cylinder is capable of being telescopically extended through the introduction of hydraulic fluid into the second hydraulic cylinder;
a hydraulic fluid reservoir;
a pneumatically actuated pump for introducing hydraulic fluid into the first and second hydraulic cylinders, wherein the pump has a first port in fluid communication with the hydraulic fluid reservoir and a second port in fluid communication with the first and second hydraulic cylinders and a pneumatically actuated impeller disposed to pump hydraulic fluid between the hydraulic fluid reservoir and the hydraulic cylinders; and
a control mechanism to actuate the pneumatically actuated pump.
